(19) United States
(12) Patent Application Publication
(10) Pub. No.: US 2005/0255210 A1
(43) Pub. Date: Nov. 17, 2005

(54) Shaped food containing soybean 7s protein and process for producing the same

(76) Inventors: Toshimitsu Baba, Izumisano-shi (JP); Tetsuhiko Okajima, Izumisano-shi (JP); Motohiko Hirotsuka, Izumisano-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/509,574

(22) PCT Filed: Apr. 2, 2003
(86) PCT No.: PCT/JP03/04203

§ 371 Date: Sep. 29, 2004

(30) Foreign Application Priority Data
Apr. 2, 2002 (JP) 2002-099811

(51) Int. Cl. A21D 10/00

(52) U.S. Cl. 426/549

(57) ABSTRACT

To easily take soybean 7S globulin in an effective amount appropriate for the purpose (for example, such an amount as expected as efficacious in achieving a physiological effect of controlling neutral fat level in blood), it is intended to provide a shaped food having a favorable taste and a process for producing the same. It is secondarily intended to provide a processing method appropriate for preparing such a food with a favorable taste without inhibiting the detection of the 7S component. A process for producing a shaped food characterized by comprising swelling a moisture-containing soybean 7S protein dough by heating and drying. In this process, more specifically speaking, the dough contains 30% by weight or more (in terms of solid matters) of soybean 7S protein and 10% by weight or more of a starch material, the heat swelling is performed by sandwich-heating or microwave heating so as to lower the moisture content after heat swelling to 30% by weight or less, and the moisture content is finally lowered to 12% by weight or less. Although the drying may be carried out by heat swelling means, it is preferable to employ an additional drying step.

### TECHNICAL FIELD

The present invention relates to a shaped food containing soybean 7S protein and a process for producing the same.

### BACKGROUND ART

Soybeans and processed products thereof are important protein sources in our dietary life, and various components thereof are known to have a physiological condition controlling function.

Storage protein of soybeans precipitates in the vicinity of pH 4.5, and can be relatively easily separated from whey. This storage protein is called as isolated soybean protein, which is utilized in food industries in this form in most cases. The protein components constituting soybean protein are classified into globulins 2S, 7S, 11S and 15S according to their sedimentation constants by ultracentrifugal analysis.

Among these protein components, 7S globulin and 11S globulin are major constituent protein components of the globulin fraction (note: 7S globulin and 11S globulin are classification names by the sedimentation method, and substantially correspond to β-conglycinin and glycinin, respectively, by immunological nomenclature). 7S Globulin is composed of several subunits, i.e., 7S globulin is composed of three subunits of α, α′ and β subunits, while 11S globulin is composed of several subunits which are pairs of acidic polypeptides (A) and basic polypeptides (B).

Since both protein components have different properties in viscosity, coagulability, surface activity, etc., it is possible to utilize respective properties of both protein components by fractionating soybean protein into a 7S globulin-rich fraction and a 11S globulin-rich fraction, and broad industrial applications of these protein components can be expected.

While the proportion of 7S globulin:11S globulin in typical soybeans is substantially considered to be 1:2, Samoto (Biosci. Biotechol. Biochem., Vol. 62, No. 5, 935-940, 1998) has reported that the presence of another lipid-associated protein and the amount thereof in industrially produced isolated soybean protein is about 35%. Accordingly, the content of 7S globulin is not more than ⅓ of conventional isolated soybean protein. Then, for ingesting a given amount of 7S globulin from isolated soybean protein, the intake of isolated soybean protein should be as much as 3 times or more of the amount of 7S globulin. Then, methods for efficiently obtaining a 7S globulin-rich fraction from soybean protein, to obtain 7S globulin-rich soybeans per se, and techniques for reducing lipid-associated protein have been investigated.

Conventionally, as for physiological functions of 7S globulin, for example, serum triglyceride reducing activity has been investigated (Okita, J. Nutr. Sci. Vitaminol., 27, 379-388, 1981). According to recent researches, serum triglyceride tends to increase as the lipid intake increases, and neutral lipid as well as blood cholesterol have been noticed as two major factors of hyperlipidemia (Research on National Nutrition, National Ministry of Welfare and Labor, 1999). Since hyperlipidemia is related to onset of arteriosclerosis that may lead to cerebrovasular and heart diseases, decreasing serum triglyceride is quite significant. In addition, since ingested lipid tends to cause obesity that may cause hypertension and liver diseases, 7S globulin is also significant for improving lipid metabolism in a living body.

Since a meat diet has been increased as a result of diversity of the dietary life, a balance between a meat diet and a vegetable diet is disturbed. Therefore, it is difficult to ingest at least 5 g of 7S globulin, that is an effective amount for suppressing serum triglyceride (KAMBARA Therapeutic Research vol. 23 no. 1 2002), from common food. While it is desirable to ingest soybean 7S protein in a low water content state in order to efficiently ingest a required amount of soybean 7S protein, dry powder of soybean 7S protein is difficult to eat because it is highly hygroscopic and becomes very viscous upon hydration.

An object of the present invention is to obtain a food excellent in taste in order to facilitate the ingestion of an effective amount of soybean 7S globulin according to a particular purpose, for example, that for expecting a physiological effect for suppressing serum triglyceride. The present inventors have studied to achieve this object and found that expansion processing is suitable. However, the present inventors have also found that, sometimes, expansion processing may impair the characteristics of protein to be detected as soybean 7S protein (soybean 7S protein cannot be detected by electrophoresis using a SDS-polyacrylamide gel). Accordingly, another object of the present invention is to provide a processing method which is suitable for producing such a food excellent in taste without adverse affect on the detection of 7S component.

### DISCLOSURE OF THE INVENTION

The present inventors have studied intensively to achieve the above objects and, as a result, have attained the present invention. That is, the present invention provides:
(1) A process for producing a shaped food which comprises expanding hydrated dough containing soybean 7S protein by heating, followed by drying the expanded dough;
(2) The process for producing the shaped food according to (1), wherein the hydrated dough contains a starchy substance;
(3) The process for producing the shaped food according to (2), wherein the dough contains not less than 30% by weight of soybean 7S protein and not less than 10% by weight of the starchy substance in the solids content of the dough;
(4) The process for producing the shaped food according to (1), wherein the dough is expanded by sandwich baking or microwave heating;
(5) The process for producing the shaped food according to (1), wherein the final water content in the shaped food is not more than 12% by weight;
(6) The process for producing the shaped food according to (1), wherein the water content in the dough at the completion of expansion by heating is not more than 30% by weight; and
(7) A shaped food obtained by the process according to any one of (1) to (6).

### BRIEF DESCRIPTION OF DRAWINGS

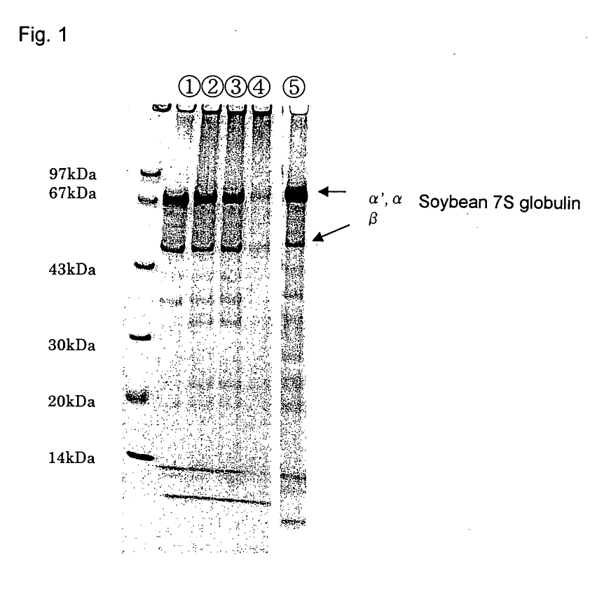

FIG. 1 shows SDS-PAGE patterns of 7S protein as the starting material and proteins in Examples 1 and 9:
1: soybean 7S protein (S-1),
2: soybean 7S protein after baking for 4 minutes,
3: soybean 7S protein after baking for 6 minutes,
4: soybean 7S protein after baking for 8 minutes, and
5: Example 9.

### BEST MODE FOR CARRYING OUT THE PRESENT INVENTION

Soybean 7S protein may be any known 7S protein. For example, the protein is obtained by utilizing the difference in isoelectric points (JP 55-124457 A), by utilizing the difference in reactivity with calcium (JP 48-56843 A), by utilizing the difference in solubility depending upon pH and ionic strength (JP 49-31843 A), by adjusting a slurry obtained by isoelectric precipitation to pH 5.0 to 5.6, and adjusting sodium chloride concentration to a molar concentration of 0.01 to 0.2 M to separate 7S and 11S fractions (JP 58-36345 A), or by utilizing a cryogenic precipitation phenomenon and a reducing agent (referred to as a cryogenic precipitation phenomenon) (JP 61-187755 A). Further, the protein can be separated from a 11S globulin-deficient soybean breed, i.e., 7S globulin-rich rich soybeans (Breeding Science, 46, 11, 1996; Breeding Science, 50, 101, 2000; and U.S. Pat. No. 6,171,640 B1).

In addition, the protein obtained according to a method for separating 7S and 11S globulins form defatted soybeans with phytase can also be suitably used (Saito, Biosci. Biotechnol. Biochem., Vol. 65, No. 4, 88-887, 2001).

7S Protein containing not less than 40% of 7S globulin can be obtained by using the protein prepared any methods described above. Further, the higher the purity of 7S globulin of the protein is, the more the resulting food facilitates the ingestion of a required amount of 7S globulin. More specifically, as the purity of the protein becomes higher, for example, 60% or more, 80% or more, 85% or more, or 90% or more, the ingestion of a required amount of 7S globulin is much more facilitated.

The amount of 7S globulin used herein means the amount measured by the following method. That is, the analysis was carried out by SDS-PAGE according to the method of Laemmli (Nature, 227, 680, 1970) with applying 10 μg of a sample, and using a gradient gel at a gel concentration of 10 to 20%. The electrophoresis pattern obtained by the above SDS-PAGE was measured with a densitometer, and the area ratio of 7S globulin to the total area of the pattern was regarded as the purity of 7S globulin (SPE basis). The content of 7S globulin used herein is expressed by the total amount of α, α′ and β subunits. While the results of the analysis by this method includes lipid-associated protein as described above, lipid-associated protein is not excluded unless otherwise stated. A corrected purity of 7S globulin, wherein the above lipid-associated protein present is excluded if necessary, can be determined by subtracting 10 times the following “chlo-metha” oil content as shown in the following equation:
“Chlo-metha” oil content: To a dry sample is added 50-fold amount of a chloroform-methanol mixed solvent (2:1 v/v), and the fraction extracted at 160° C. is weighed.
Corrected purity=(100% −“chlo-metha” oil content %×10)×(% based on SPE)/100

Since dry powder of 7S protein is quite hygroscopic as compared with isolated soybean protein powder and tends to form undissolved lumps upon mixing with water, a mixer generating good shear force such as a cutting apparatus called as a food cutter or a silent cutter is preferably used for preparing hydrated dough by mixing 7S protein powder with water. Dispersibility as well as taste of 7S protein powder can be somewhat improved by forming hydrated dough of protein together with a starchy substance such as corn, waxycorn, potato, tapioca, wheat or rice starch or modified starch thereof, or cereal flour such as wheat flour or rice flour.

In view of the objectives of the present invention, the content of soybean 7S protein in the solids content of dough is preferably not less than 30% by weight. The above dispersibility and taste can be improved by adding not less than 10% by weight of the starchy substance. For efficient ingestion of soybean 7S protein, the content of the starchy substance is preferably not more than 45% by weight, more preferably not more than 30% by weight.

The content of water in hydrated dough somewhat varies depending upon the content of 7S globulin in 7S protein and the presence or the absence of the starchy substance. The amount of water should be at least that enough for hydrating the 7S protein and starchy substance. For example, when the starchy substance is not present, the amount of water should be at least 2.5 times as much as that of 7S protein. A good texture cannot be formed by heat expansion when hydration of 7S protein is insufficient. On the contrary, when the content of water is too large, a texture can hardly be formed by heat expansion, and a final drying process takes a long period of time.

Spice and seasoning may be added for giving a flavor to dough in the present invention, and their content is 10% at most, and is usually suppressed to be not more than 5% by weight.

In the present invention, oils and fats may also be added, but their content is preferably suppressed to be not more than 5% in dough when the objective of ingestion of 7S protein is, for example, to reduce serum triglyceride.

The hydrated dough of soybean 7S protein is subjected to heat-expansion, and then dried. The heat-expansion is a kind of formation of a texture by heating dough to vaporize water in the dough and, in general, the hydrated dough should be heated so that a product temperature of hydrated dough exceeds the boiling point of water. Examples of such heating include heating dough by sandwiching it between hot plates (hereinafter referred to as “sandwich baking”), and irradiation of a microwave. When this texture formation is insufficient, mouthfeel is impaired, and a texture with a hard center or a dense texture is resulted. This is undesirable from a view point of taste. Then, heating is carried out until the water content of dough becomes not more than 30% by weight, preferably not more than 25% by weight. Even if a texture is formed by heat-expansion, desired mouthfeel cannot be obtained unless the dough is sufficiently dried. Drying is preferably carried out in a separate drying step, while the dough may be dried only by heat-expansion. In any event, drying is carried out so that a final water content is not more that 12% by weight. This final water content somewhat varies depending upon the desired mouthfeel. When hard and crispy feeling like a rice cracker is desired, the final water content is preferably 1 to 5%. When soft and crispy feeling like a bread and a rusk is desired, the final water content is preferably in the range of 5 to 12%.

In case of carrying out drying by a separate step, for preventing lowering of the amount of soybean 7S protein to be detected, drying is preferably started at a stage where the water content of dough after heat-expansion is, at the lowest, not lower than 5%, preferably not lower than 7%. The drying is preferably carried out under conditions that a dough temperature does not exceed 100° C. with controlling environment humidity and ventilation speed. For example, an air blow drier or a static drier can be used.

The following. Examples illustrate the advantages of the present invention but are not to be construed to limit the technical idea of the present invention.

### PRODUCTION EXAMPLE 1

[Preparation of Soybean 7S Protein (S-1)]

Water for extraction at 40° C. was added to defatted soybean in a weight ratio of 1 (soybeans):10 (water), and pH of the mixture was adjusted to 5.3 with hydrochloric acid. After adding 8 units of phytase (trade name Phytase Novo, manufactured by Novo Industry) per protein to this solution, the enzymatic reaction was carried out at 40° C. for 30 minutes to obtain extract slurry treated with the enzyme. The extract slurry treated with the enzyme was cooled to 25° C., adjusting to pH 6.1 and then centrifuged (3000 G). The resulting soluble fraction was adjusted to pH 4.9 with hydrochloric acid and centrifuged to obtain precipitated curd. This precipitated curd was washed with 10 times as much volume of water, followed by addition of 4 times as much weight of water. The mixture was neutralized to pH 7.0 with sodium hydroxide, sterilized at 140° C. for 15 seconds, and then spray-dried to obtain 7S protein having a low phytic acid content and high purity (97%) (hereinafter referred to as S-1) . As seen from the SDS-PAGE pattern in FIG. 1-(1), the purity of 7S protein is high.

A mix of 50 parts of soybean 7S protein (S-1), 45 parts of rice flour and 5 parts of “Nori-Shio” (trade name) seasoning powder was placed in a mixer, 150 parts of water was slowly added thereto with stirring, and the resulting mixture was kneaded to obtain dough. This dough was divided into pieces of 8 g, and each piece was heated and dried for 7 minutes at 180° C. between iron plates capable of sandwich-baking to obtain a shaped food. When the finished shaped food was evaluated, it had the water content of 3.5% by weight, and had a good flavor with crispy mouthfeel.

When the sandwich-heating times were changed for 4 minutes (2), 6 minutes (3) and 8 minutes (4), the water contents of dough after heat-expansion were 24.6%, 9.2% and 1.5%, respectively. The samples in the former two conditions were further dried by allowing to stand the test pieces overnight in an incubator at 30° C. equipped with a fan (water content after drying was about 3%). The SDS-PAGE patterns of these samples are shown in FIG. 1. That is, the peak of the 7S protein is not disappear under appropriate drying conditions (conditions (2) and (3)), while the peak is disappeared under severe conditions (4).

### EXAMPLE 2

A mix of 70 parts of soybean 7S protein (S-1), 25 parts of rice flour and 5 parts of “Nori-Shio” (trade name) seasoning powder was placed in a food cutter, 200 parts of water was slowly added thereto with stirring, and the resulting mixture was homogenized and kneaded with hands to obtain dough. This dough was divided into pieces of 8 g, and each piece was dried for 6 minutes at 180° C. between iron plates capable of sandwich-baking, followed by drying at 50° C. in an air stream for 3 hours to prepare a shaped food. When the finished shaped food was evaluated, it had the water content of 12.9% by weight after sandwich-baking and the water content of 3.4% by weight after the final drying. The shaped food had a good flavor with crispy mouthfeel.

A mix of 50 parts of soybean 7S protein (S-1), 45 parts of wheat flour and 5 parts of “Nori-Shio” (trade name) seasoning powder was placed in a mixer, 150 parts of water was slowly added thereto with stirring and the resulting mixture was kneaded to obtain dough. The dough was molded in a round shape of 3 mm thick and 5 cm diameter, heated in a 500 W microwave oven for 1 minute and 30 seconds, and dried for 8 hours in an air stream at 30° C. to obtain a shaped food. When the finished shaped food was evaluated, it had the water content of 13.5% by weight after heating with the microwave oven and the water content of 9.8% by weight after final drying. The shaped food had a good flavor with crispy mouthfeel.

### EXAMPLES 4 TO 9

According to the same manner as that described in Examples 1 to 3, shaped foods were obtained except that the formulations, and heating and drying conditions were changed as shown in the following Tables.

TABLE 1-1
Formulation
Unit: part

| | Example 1 | Example 2 | Example 3 | Example 4 | Example 5 | Example 6 | Example 7 | Example 8 | Example 9 |
|---|---|---|---|---|---|---|---|---|---|
| S-1 | 50 | 70 | 50 | 95 | 30 | 30 | 30 | 50 | 50 |
| Rice flour | 45 | 25 | — | — | — | — | 65 | 45 | — |
| Wheat flour | — | — | 45 | — | — | — | — | — | 45 |
| “G-300” | — | — | — | — | 70 | — | — | — | — |
| “Nyuka W” | — | — | — | — | — | 70 | — | — | — |
| Seasoning | 5 | 5 | 5 | 5 | — | — | 5 | 5 | 5 |
| Water | 150 | 200 | 150 | 255 | 90 | 115 | 140 | 150 | 150 |

The seasoning used was “Nori-Shio” (trade name) seasoning powder, “G-300” (trade names) was starch manufactured by Nichiden Kagaku K. K., and “Nyuka W” (trade name) was starch manufactured by Nichiden Kagaku. K.K.

TABLE 1-2
Heat-Drying Conditions,
Unit: Heating ° C., Drying ° C.

| | Example 1 | Example 2 | Example 3 | Example 4 | Example 5 | Example 6 | Example 7 | Example 8 | Example 9 |
|---|---|---|---|---|---|---|---|---|---|
| Heating | 180 | 180 | — | 180 | 180 | 180 | 200 | 130 | — |
| conditions | Sandwich | Sandwich | Microwave | Sandwich | Sandwich | Sandwich | Sandwich | Sandwich | Microwave |
| | heating | heating | 90 seconds | heating | heating | heating | heating | heating | 85 seconds |
| | 7 minutes | 6 minutes | | 6 minutes | 7 minutes | 6 minutes | 3 minutes | 10 minutes | |
| Drying | — | Hot air | Hot air | Hot air | — | Hot air | Hot air | Hot air | Hot air |
| conditions | | 50° C. | 30° C. | 50° C. | | 30° C. | 140° C. | 50° C. | 30° C. |
| | | 3 hours | 8 hours | 3 hours | | 8 hours | 5 minutes | 10 hours | 12 hours |

TABLE 1-3
Evaluation, Unit: moisture % by weight

| | Example 1 | Example 2 | Example 3 | Example 4 | Example 5 | Example 6 | Example 7 | Example 8 | Example 9 |
|---|---|---|---|---|---|---|---|---|---|
| Water content | — | 12.9 | 13.5 | 14.3 | — | 13.3 | 24.1 | 22.1 | 22.0 |
| after heating | | | | | | | | | |
| Water content | 3.5 | 3.4 | 9.8 | 3.9 | 2.5 | 8.7 | 3.1 | 3.9 | 11.0 |
| in final | | | | | | | | | |
| product | | | | | | | | | |
| Feeling test | | | | | | | | | |
| Mouthfeel | Very good | Very good | Good | Good | Very good | Good | Very good | Very good | Good |
| Flavor | Good | Good | Good | Good | Good | Good | Good | Good | Good |

All the shaped foods in Examples 1 to 8 were expanded, and had crispy mouthfeel with a good flavor. The shaped food in Example 9 was further expanded with a porous texture, and gave light, soft and crispy mouthfeel with a good flavor.

### COMPARATIVE EXAMPLE 1

A mix of 50 parts of soybean 7S protein (S-1), 45 parts of rice flour and 5 parts of “Nori-Shio” (trade name) seasoning powder was placed in a mixer, 150 parts of water was slowly added thereto with stirring and the resulting mixture was kneaded to obtain dough. The dough was divided into pieces of 8 g, and each piece was heated and drying between iron plates capable of sandwich baking at 180° C. for 5 minutes to prepare a shaped food. When the finished shaped food was evaluated, it had the water content of 14.2% by weight, and was hard to eat without crispy mouthfeel. However, when the shaped food is dried with hot air to the water content of not more than 12%, preferably not more than 7%, the food was finished desirably with a good flavor and good mouthfeel.

### COMPARATIVE EXAMPLE 2

A mix of 50 parts of soybean 7S protein (S-1), 45 parts of rice flour and 5 parts of “Nori-Shio” (trade name) seasoning powder was placed in a mixer, 150 parts of water was slowly added thereto with stirring and the resulting mixture was kneaded to obtain dough. The dough was divided into pieces of 8 g, each piece was heated between iron plates capable of sandwich baking at 70° C. for 30 minutes and the baked piece was dried in an air stream at 50° C. for 15 hours to obtain a shaped food. When the finished shaped food was evaluated, it had the water content of 39.9% by weight after sandwich-baking and the water content of 3.9% by weight after the final drying. The shaped food had a hard center due to insufficient expansion and hard mouthfeel, and was hard to eat.

### COMPARATIVE EXAMPLE 3

A mix of 50 parts of soybean 7S protein (S-1), 45 parts of rice flour and 5 parts of “Nori-Shio” (trade name) seasoning powder, 150 parts of water was slowly added thereto with stirring and the resulting mixture was kneaded to obtain dough. The dough was divided into pieces of 8 g, each piece was heated between iron plates capable of sandwich baking at 180° C. for 2 minutes, and the baked piece was dried in an air stream at 50° C. for 15 hours to obtain a shaped food. When the finished shaped food was evaluated, it had the water content of 43.3% by weight after sandwich-baking and the water content of 3.6% by weight after the final drying. The shaped food had a hard center due to insufficient expansion and hard mouthfeel, and was hard to eat.

### COMPARATIVE EXAMPLE 4

A mix of 50 parts of soybean 7S protein (S-1), 45 parts of wheat flour and 5 parts of “Nori-Shio” (trade name) seasoning powder, 150 parts of water was slowly added thereto with stirring and the resulting mixture was kneaded to obtain dough. The dough was molded into a round shape of 3 mm thick and 5 cm diameter, heated in a 500 W microwave oven for 75 seconds, and dried for 12 hours in an air stream at 40° C. to obtain a shaped food. When the finished shaped food was evaluated, it had the water content of 34.5% by weight after heating with the microwave oven and the water content of 11.5% by weight after the final drying. The shaped food had a hard texture due to insufficient expansion, and was hard to eat.

### INDUSTRIAL APPLICABILITY

According to the present invention, it is possible to produce a shaped food excellent in taste by expanding dough containing not less than 30% by weight of 7S protein by heating and then drying the expanded product.

1. A process for producing a shaped food which comprises expanding hydrated dough containing soybean 7s protein by heating, followed by drying the expanded dough:

2. The process for producing the shaped food according to claim 1, wherein the hydrated dough contains a starchy substance.

3. The process for producing the shaped food according to claim 2, wherein the dough contains not less than 30% by weight of soybean 7S protein and not less than 10% by weight of the starchy substance in the solids content of the dough.

4. The process for producing the shaped food according to claim 1, wherein the dough is expanded by sandwich baking or microwave heating.

5. The process for producing the shaped food according to claim 1, wherein the final water content in the shaped food is not more than 12% by weight.

6. The process for producing the shaped food according to claim 1, wherein the water content in the dough at the completion of expansion by heating is not more than 30% by weight.

7. A shaped food obtained by the process according to claim 1.

8. A shaped food obtained by the process according to claim 2.

9. A shaped food obtained by the process according to claim 3.

10. A shaped food obtained by the process according to claim 4.

11. A shaped food obtained by the process according to claim 5.

12. A shaped food obtained by the process according to claim 6.
